(19) United States
(12) Patent Application Publication
(10) Pub. No.: US 2025/0321748 A1
(43) Pub. Date: Oct. 16, 2025

(54) CHIP BOOT METHOD, CHIP, ELECTRONIC DEVICE, AND READABLE STORAGE MEDIUM

(71) Applicant: Huawai Technologies Co., Ltd., Shenzhen (CN)

(72) Inventors: Xudong Zhu, Shenzhen (CN); Meng Jin, Shanghai (CN); Bao Zhang, Shanghai (CN); Jingjing Yao, Shanghai (CN)

(21) Appl. No.: 19/253,137

(22) Filed: Jun. 27, 2025

Related U.S. Application Data
(63) Continuation of application No. PCT/CN2023/138490, filed on Dec. 13, 2023.

(30) Foreign Application Priority Data
Dec. 30, 2022 (CN) 202211741660.6

(51) Int. Cl. G06F 9/4401; G06F 8/61; G06F 11/07

(52) U.S. Cl. CPC G06F 9/4403; G06F 8/63; G06F 11/0772

(57) ABSTRACT

This application provides a chip boot method, a chip, an electronic device, and a readable storage medium. In the method, when a chip is booted, whether a first image needs to be burnt in a non-volatile memory is detected, where the first image is an image that is run by the chip when an electronic device is in a power-off state; and different boot operations are performed based on a status of the electronic device and a result of whether the first image needs to be burnt in the non-volatile memory, where the status of the electronic device includes a power-on state and the power-off state.

### CROSS-REFERENCE TO RELATED APPLICATIONS

This application is a continuation of International Application No. PCT/CN2023/138490, filed on Dec. 13, 2023, which claims priority to Chinese Patent Application No. 202211741660.6, filed on Dec. 30, 2022. The disclosures of the aforementioned applications are hereby incorporated by reference in their entireties.

### TECHNICAL FIELD

Embodiments of this application relate to the field of communication technologies, and in particular, to a chip boot method, a chip, an electronic device, and a readable storage medium.

### BACKGROUND

With development of communication technologies, types of chips gradually increase, and an electronic device depends on the chip to implement functions such as communication and computation. There are two types of communication chips: One type of chip cannot operate when the electronic device is powered off; and the other type of chip can operate when the electronic device is powered off, but has a poor processing capability.

Currently, there is a requirement that the electronic device can implement communication in both a power-on state and a power-off state. A current communication chip cannot meet the requirement.

### SUMMARY

Embodiments of this application provide a chip boot method, a chip, an electronic device, and a readable storage medium, to ensure that the electronic device can implement communication in a power-on state or a power-off state.

According to a first aspect, an embodiment of this application provides a chip boot method. The method may be performed by a chip or a module in the chip. The following uses the chip as an example for description. In the method, when the chip is booted, the chip may detect whether a first image needs to be burnt in a non-volatile memory. The first image is an image that is run by the chip when an electronic device is in a power-off state. The chip may perform different boot operations based on a status of the electronic device and a result of whether the first image needs to be burnt in the non-volatile memory. The status of the electronic device includes a power-on state and the power-off state.

In this application, when the electronic device is in the power-on state or the power-off state, the chip can perform the different boot operations. This can ensure that the electronic device can implement communication in the power-on state or the power-off state.

In a possible implementation, the chip may detect whether the first image exists in the non-volatile memory, and detect whether a burning flag is written in the non-volatile memory. The burning flag indicates that the first image needs to be burnt in the non-volatile memory.

In a possible implementation, when the first image in a host is updated, the host may notify the chip that the first image is already updated. Correspondingly, the chip may receive an update notification from the host in the electronic device. The update notification indicates that the first image in the host is already updated. The chip may write the burning flag in the non-volatile memory. This helps the chip detect, based on the burning flag, whether the first image needs to be burnt in the non-volatile memory.

When the first image exists in the non-volatile memory, and the burning flag is not written in the non-volatile memory, the result is that the first image does not need to be burnt in the non-volatile memory. When the first image does not exist in the non-volatile memory, or the burning flag is written in the non-volatile memory, the result is that the first image needs to be burnt in the non-volatile memory.

In a possible implementation, the chip may detect whether the first image exists in the non-volatile memory. When the first image exists in the non-volatile memory, the result is that the first image does not need to be burnt in the non-volatile memory. When the first image does not exist in the non-volatile memory, the result is that the first image needs to be burnt in the non-volatile memory.

In a possible implementation, the chip may detect, in any one of the following cases, whether the first image needs to be burnt in the non-volatile memory:

in response to power on of the chip, the chip may detect whether the first image needs to be burnt in the non-volatile memory; or in response to reset of the chip, the chip may detect whether the first image needs to be burnt in the non-volatile memory; or in response to power on or power off of the electronic device, the chip may detect whether the first image needs to be burnt in the non-volatile memory.

In a possible implementation, the chip may further detect the status of the electronic device. The chip may detect the status of the electronic device when detecting whether the first image needs to be burnt in the non-volatile memory. There is no sequence between detecting, by the chip, whether the first image needs to be burnt in the non-volatile memory and detecting the status of the electronic device.

The following describes the different boot operations performed by the chip in different states of the electronic device based on the result of whether the first image needs to be burnt in the non-volatile memory.

1. When the electronic device is in the power-off state, and the first image does not need to be burnt in the non-volatile memory, the chip may load the first image from the non-volatile memory, and run the first image.

2. When the electronic device is in the power-off state, and the first image needs to be burnt in the non-volatile memory, the chip may wait for the electronic device to be powered on. In addition, when the electronic device is powered on, it is detected whether the first image needs to be burnt in the non-volatile memory.

3. When the electronic device is in the power-on state, the chip may perform a handshake with a host in the electronic device. The host includes the first image and a second image. The second image is an image that is run by the chip when the electronic device is in the power-on state. The first image is different from the second image.

When the handshake between the chip and the host succeeds, if the first image does not need to be burnt in the non-volatile memory, the chip may load the second image from the host to a memory of the chip, and run the second image in the memory. When the handshake between the chip and the host succeeds, if the first image needs to be burnt in the non-volatile memory, the chip may load the first image from the host to the non-volatile memory, and reset after the loading is completed.

In a possible implementation, before loading the first image from the host to the non-volatile memory, the chip may load a bootloader image from the host to the memory of the chip, and run the bootloader image in the memory. After running the bootloader image in the memory, the chip can load the first image from the host to the non-volatile memory.

In a possible implementation, when the handshake between the chip and the host fails, the chip may wait for the host to reset. In addition, when the host resets, the chip may perform reset.

In this application, the chip can execute different strategies based on the status of the electronic device and the result of whether the first image needs to be burnt in the non-volatile memory. This can ensure that the electronic device can implement communication in the power-on state or the power-off state. In addition, when the electronic device is in the power-on state, the chip can load the second image from the host to the memory, and the host provides a protocol stack and an application that have strong processing capabilities. This can meet a requirement of a user for high network performance.

In a possible implementation, the chip is connected to the host through a first interface and a second interface. When the electronic device is in the power-on state, the method further includes: The chip starts a timer to perform timing, where timing duration is preset duration.

If the chip receives a handshake signal from the host through the first interface within the preset duration, the chip determines that the handshake with the host succeeds. If the chip does not receive the handshake signal from the host through the first interface within the preset duration, the chip detects whether a level of a preset pin of the chip is set to a preset level. The preset pin corresponds to the second interface.

If the level of the preset pin is set to the preset level, the chip determines to perform the handshake with the host through the second interface.

In this application, a corresponding pin may not be disposed for the first interface. This can reduce pin overheads.

In a possible implementation, the first image includes a communication image. The communication image is used to implement communication when the electronic device is powered off. In a possible implementation, the first image further includes an application image. The application image is used to implement a function of an application when the electronic device is powered off.

In this possible implementation, different first images can be designed, so that after the first electronic device is powered off, the chip of a second electronic device runs the different first images, and performs different operations, to implement different functions.

In a possible implementation, the application image is specifically used to: when the electronic device is powered off, trigger the chip to send a broadcast. The broadcast is used to retrieve the electronic device.

In this possible implementation, a function of retrieving the electronic device when the electronic device is powered off can be implemented, without additionally adding a Bluetooth chip to the first electronic device. This can reduce costs and simplify setting of the electronic device.

According to a second aspect, an embodiment of this application provides a chip. The chip includes a computer program or instructions. When the computer program or the instructions are run, the method according to the first aspect is implemented.

In an embodiment, the chip may further include a non-volatile memory.

According to a third aspect, an embodiment of this application provides an electronic device. The electronic device may include a processor, a memory, and the chip according to the second aspect.

According to a fourth aspect, an embodiment of this application provides an electronic device. The electronic device may include a unit, a module, or a circuit configured to perform the method provided in the first aspect.

According to a fifth aspect, an embodiment of this application provides a chip boot system. The chip boot system may include the electronic device according to the third aspect or the electronic device according to the fourth aspect. In an embodiment, the chip boot system may further include the chip according to the second aspect.

According to a sixth aspect, an embodiment of this application provides a program product including instructions. When the program product runs on a computer, the method according to the first aspect can be implemented.

According to a seventh aspect, an embodiment of this application provides a computer-readable storage medium. The computer-readable storage medium stores instructions. When the instructions are run, the method according to the first aspect can be implemented.

For beneficial effect of the possible implementations of the second aspect to the seventh aspect, refer to the beneficial effect brought by the first aspect. Details are not described herein again.

### BRIEF DESCRIPTION OF DRAWINGS

FIG. 1A is a diagram of a structure of an electronic device;

FIG. 1B is a diagram of another structure of an electronic device;

FIG. 2 is a diagram of a structure of an existing second-type communication chip;

FIG. 3 is a diagram of a boot procedure of a second-type communication chip;

FIG. 4 is a diagram of a structure of an electronic device according to an embodiment of this application;

FIG. 5 is a schematic flowchart of an embodiment of a chip boot method according to an embodiment of this application;

FIG. 6 is a diagram of a system architecture to which a chip boot method is applicable according to an embodiment of this application;

FIG. 7A is a diagram of a scenario to which a chip boot method is applicable according to an embodiment of this application;

FIG. 7B is a diagram of another scenario to which a chip boot method is applicable according to an embodiment of this application;

FIG. 8 is a schematic flowchart of another embodiment of a chip boot method according to an embodiment of this application; and

FIG. 9 is a diagram of another structure of an electronic device according to an embodiment of this application.

### DETAILED DESCRIPTION OF THE ILLUSTRATIVE EMBODIMENTS

Explanations of terms in this application are as follows.

A host is a main body part other than an input/output device in an electronic device, and is also a control cabinet body used to place a motherboard and another main component. In an example, the host may include a central processing unit (CPU), a memory, the motherboard, a CD-ROM drive, a power supply, another input/output controller, an interface, and the like of the electronic device. In an example, the host in the electronic device may be a system on chip (SoC).

A protocol stack, also referred to as a protocol stack, is a specific software implementation. The protocol stack defines a communication mode, and may describe a time sequence of a signal and a structure of communication data. In an example, a rule followed by vendors is defined at a lower layer of the protocol stack, so that devices of different vendors can be interconnected with each other. How to manage different types of communication sessions is defined at an upper layer of the protocol stack. The protocol stack may be a sum of protocols at all layers, and vividly reflects a file transmission process on a network: from an upper layer protocol to a bottom layer protocol, and then from the bottom layer protocol to the upper layer protocol.

It should be understood that different types of protocol stacks include different protocols at all layers. In embodiments of this application, a protocol stack of a transmission control protocol/internet protocol (TCP/IP) is used as an example for description.

An image is an image file. Embodiments of this application relate to a system image, a communication image, an application image, and the like. The system image is, for example, an Opsystem.bin file. A chip runs the system image, to start an operating system of the chip. The communication image may include a Wi-Fi image, a Bluetooth image, and the like. The chip runs the communication image to implement communication via a communication module. The chip runs the application image to implement a function of an application. In an example, the Wi-Fi image may be firmware for implementing Wi-Fi communication, and the Bluetooth image may be firmware for implementing Bluetooth communication.

An electronic device in embodiments of this application may be referred to as user equipment (UE), a terminal, or the like. For example, the electronic device may be a mobile phone, a tablet computer (PAD), a personal computer (PC), a personal digital processing (PDA), a handheld device having a wireless communication function, a computing device, a vehicle-mounted device or a wearable device, a virtual reality (VR) terminal device, an augmented reality (AR) terminal device, a wireless terminal in industrial control, a wireless terminal in a smart home, or the like. A form of the electronic device is not specifically limited in embodiments of this application.

A communication chip may be disposed in the electronic device. The communication chip is configured to implement networking of the electronic device and communication with another electronic device. Currently, there are two types of communication chips that may be respectively referred to as a first-type communication chip and a second-type communication chip.

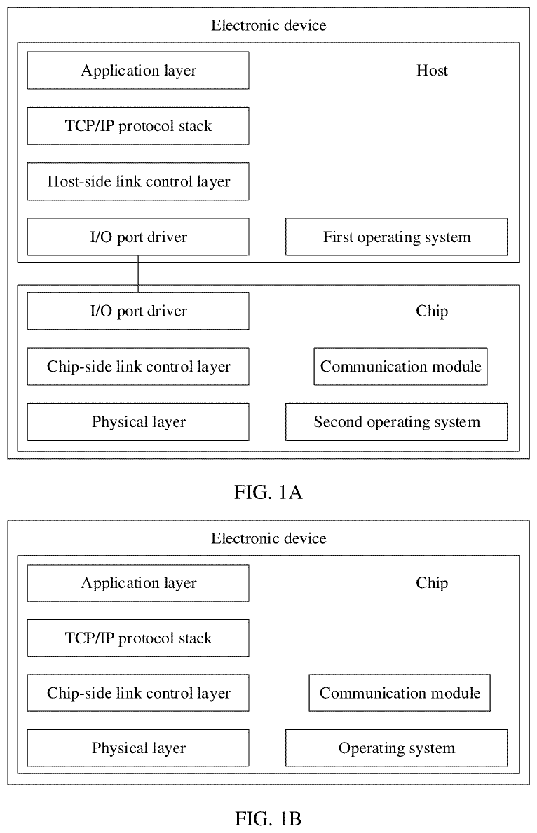

The first-type communication chip may be referred to as a non-independent operating chip, for example, a Wi-Fi chip or a Bluetooth chip. FIG. 1A is a diagram of a structure of the electronic device. With reference to FIG. 1A, the electronic device may include a host and the first-type communication chip. For example, the electronic device may be a mobile phone, a tablet computer, a PC, or the like.

The host may include an application layer, a TCP/IP protocol stack, a host-side link control layer, an input/output (I/O) port driver, and a first operating system. The first-type communication chip may include an I/O port driver, a chip-side link control layer, a physical layer, a communication module, and a second operating system. In an example, the host-side link control layer and the chip-side link control layer may be considered as link layers in a protocol stack.

The application layer is a layer at which applications communicate with each other. The layer includes all network-related upper-layer protocols, for example, a file transfer protocol, a hypertext transfer protocol, and a remote terminal protocol.

The TCP/IP protocol stack may be used as a transport layer and a network layer, may implement a session between a host and a target host, may send a packet to the target host through path selection, and may perform network congestion control, error control, and the like.

The link layer is responsible for communication between the network layer and the physical layer, may divide data received by the network layer into specific frames that can be transmitted by the physical layer, and enable the physical layer to transmit the data.

The physical layer may transmit the data via the communication module in the chip. The communication module may include, for example, a Wi-Fi radio frequency module and/or a Bluetooth radio frequency module. A type of the communication module is not limited in embodiments of this application. Correspondingly, the physical layer may transmit the data in a manner like Wi-Fi and/or Bluetooth.

An I/O port driver in the host and the I/O port driver in the first-type communication chip are configured to implement a connection between the host and the first-type communication chip.

The first operating system is used to implement running of an operating system of the host. The second operating system is used to implement running of an operating system of the first-type communication chip. The first operating system and the second operating system are not limited in embodiments of this application.

With reference to FIG. 1A, the first-type communication chip does not include an application layer, a transport layer, a network layer, and the like that are used to implement communication. Consequently, the first-type communication chip requires support of the host during operation, and cannot operate independently. When the electronic device is powered on, both the host and the first-type communication chip are powered on. The first-type communication chip may implement communication of the electronic device under the support of the host. When the electronic device is powered off, the host is powered off. Even if the first-type communication chip is in a power-on state, the first-type communication chip cannot implement a complete communication function of the electronic device due to lack of support of a protocol stack and the application on the host.

The second-type communication chip may be referred to as an independent operating chip, for example, an internet of things (IoT) chip. FIG. 1B is a diagram of another structure of the electronic device. With reference to FIG. 1B, the electronic device includes the second-type communication chip. For example, the electronic device may be a door lock, a socket, a light bulb, or the like.

The second-type communication chip includes an application layer, a TCP/IP protocol stack, a chip-side link control layer, a physical layer, a communication module, and an operating system. For the application layer, the TCP/IP protocol stack, the chip-side link control layer, the physical layer, and the communication module, refer to related descriptions in FIG. 1A. The operating system is used to implement running of the operating system of the second-type communication chip.

The second-type communication chip may implement a full-stack network protocol and the application, and may operate through support of a peripheral basic circuit. The second-type communication chip does not depend on the host, and can operate independently. For example, when the electronic device is powered off, the host is powered off, and the second-type communication chip is not powered off. For example, the second-type communication chip may continue to operate in a low power consumption mode, and may still implement communication. It should be noted that the protocol stack and the application on the second-type communication chip have weak processing capabilities. For example, processing capabilities of the protocol stack and the application on the second-type communication chip are weaker than processing capabilities of the protocol stack and the application on the host in FIG. 1A.

With diversification of user requirements, currently, there is a requirement that the electronic device can implement the communication in both a power-on state and a power-off state. For example, for a PC, when the PC is powered on, a user needs to use the PC to access the internet, work, entertain, and the like. When the PC is powered off, the user needs to use a mobile phone or a PAD to remotely power on the PC, to search for a file on the PC or remotely control the PC.

In an embodiment, the second-type communication chip may be disposed in the electronic device. The second-type communication chip does not depend on the host, and can operate independently. Therefore, the electronic device can implement the communication via the second-type communication chip in both the power-on state and the power-off state. In this embodiment, if the electronic device still uses the second-type communication chip when being powered on, although a networking function of the electronic device can be implemented, performance of the electronic device is limited. For example, when the electronic device is powered on, the user may use various applications such as a video application, a game application, and downloading of a large file. These applications have a high requirement on network performance of the electronic device, and require the protocol stack to have a strong processing capability. However, if the electronic device still uses the second-type communication chip when being powered on, because the protocol stack and the application on the second-type communication chip have the weak processing capabilities, the user requirement cannot be met.

In an embodiment, the first-type communication chip and the second-type communication chip may be disposed in the electronic device. The electronic device may use the first-type communication chip when being powered on, to meet a requirement of the user for high network performance. In addition, the electronic device may use the second-type communication chip when being powered off, to meet a requirement that is of the user and that the electronic device can still communicate when being powered off. However, in this embodiment, the two types of communication chips are disposed in the electronic device. Consequently, costs and area overheads are undoubtedly increased.

One chip may be disposed in the electronic device, to reduce the costs and the area overheads. If the one chip can implement functions of the two types of chips, a problem of switching the electronic device between two operating modes needs to be resolved. In view of this, embodiments of this application provide a chip boot method. One chip may be disposed in an electronic device. The chip implements functions of two types of chips by using different images, so that the electronic device can communicate when being powered on or powered off, and a requirement of a user for high network performance can be met when the electronic device is powered on.

For ease of understanding of the chip boot method provided in this application, the following describes a boot process of a first-type communication chip and a boot process of a second-type communication chip.

### 1. Boot Process of the First-Type Communication Chip

When the electronic device is powered on, the first-type communication chip in the electronic device is powered on. When the first-type communication chip is powered on, the first-type communication chip may run bootrom. The bootrom may be understood as 1^{st} code executed after the chip is powered on or resets. After running the bootrom, the first-type communication chip may perform a handshake with a host. The host stores an image required for running of the first-type communication chip. For example, the image may include a system image and a communication image. The communication image may include a Wi-Fi image and a Bluetooth image. After the handshake with the host succeeds, the first-type communication chip may obtain the system image and the communication image from the host, and load the system image and the communication image to a memory of the first-type communication chip. After the loading is completed, the first-type communication chip may run the system image and the communication image in the memory, for example, run the system image to run a second operating system, and run the communication image to implement Wi-Fi communication and Bluetooth communication.

The memory of the first-type communication chip is, for example, a static random-access memory (SRAM).

In this example, after the electronic device is powered off, the first-type communication chip is powered off, the image in the SRAM disappears, and the first-type communication chip cannot assist the electronic device in communication.

### 2. Boot Process of the Second-Type Communication Chip

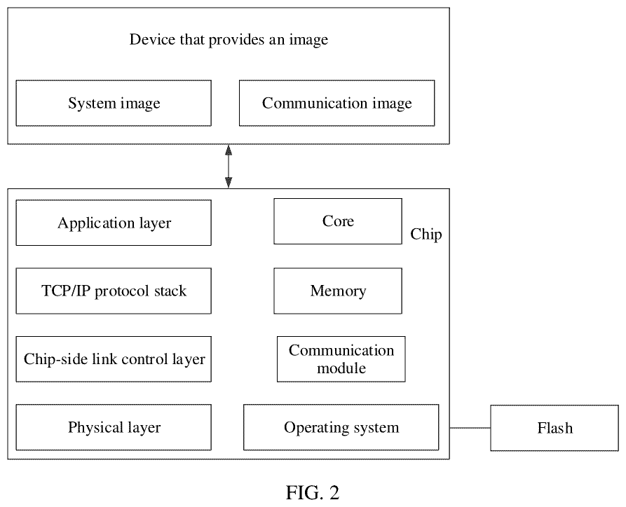

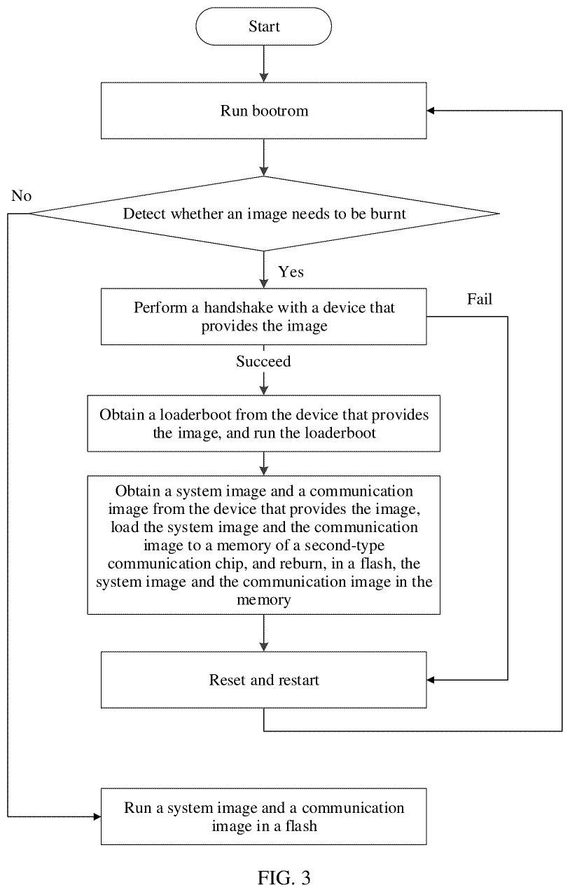

FIG. 2 is a diagram of a structure of an existing second-type communication chip. With reference to FIG. 2, a flash may be externally connected to the second-type communication chip. The second-type communication chip may burn an image in the flash. In this way, after the electronic device is powered off, the second-type communication chip can still run the image in the flash, to ensure that the electronic device can communicate. The boot process of the second-type communication chip may include a burning process and an operation process, as shown in FIG. 3.

### Burning Process

When the second-type communication chip is used for the first time or the second-type communication chip needs to burn the image, the user may connect the second-type communication chip to a device (for example, a host) that provides an image. For example, the user inserts the second-type communication chip onto an interface of a device that provides the image. The second-type communication chip runs bootrom when the second-type communication chip is connected to the device that provides the image. After running the bootrom, the second-type communication chip may detect whether the image needs to be burnt. For example, when detecting that the image does not exist in the flash or failing in detection, the second-type communication chip determines that the image needs to be burnt. In some embodiments, when detecting that the image exists in the flash but a burning flag exists in the flash, the second-type communication chip also determines that the image needs to be burnt. The burning flag indicates that the image needs to be reburnt in the flash.

When determining that the image needs to be burnt, the second-type communication chip may start communication with the device that provides the image. The device that provides the image may store a bootloader (Loaderboot) image and an image required for running of the second-type communication chip. For example, the image may include a system image and a communication image. The second-type communication chip may perform a handshake with the device that provides the image. After the handshake succeeds, the second-type communication chip may load the loaderboot from the device that provides the image, and the image required for the running the second-type communication chip.

The second-type communication chip may obtain the loaderboot from the device that provides the image, and run the loaderboot. The second-type communication chip may obtain the system image and the communication image from the device that provides the image, load the system image and the communication image to a memory of the second-type communication chip, and reburn, in the flash, the system image and the communication image in the memory.

When the handshake between the second-type communication chip and a burning module of the device that provides the image fails, the second-type communication chip may reset.

### Working Process

After the second-type communication chip reburns the system image and the communication image in the flash, the second-type communication chip resets, and runs the bootrom. After running the bootrom, the second-type communication chip may detect whether the image needs to be burnt, and because the burnt image already exists in the flash, determine that the image does not need to be burnt. The second-type communication chip may run the system image and the communication image in the flash, for example, run the system image to run the second operating system, and run the communication image to implement Wi-Fi communication and Bluetooth communication.

In this example, after the electronic device is powered off, the second-type communication chip is still in a power-on state, for example, operates in a low power consumption mode. Because the system image and the communication image are burnt in the flash, the second-type communication chip can still run the image in the flash, to implement communication of the electronic device.

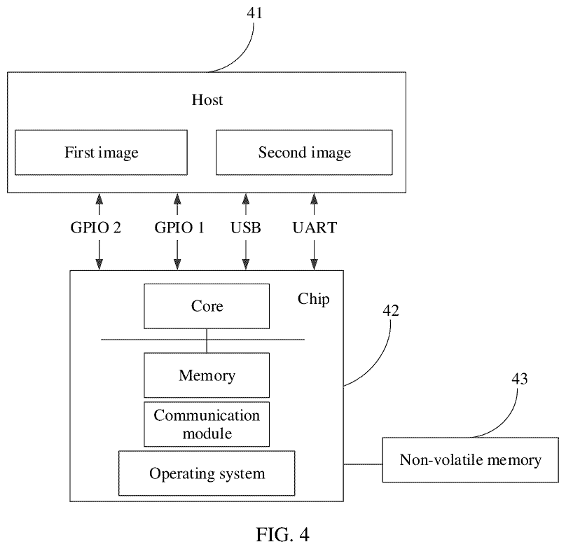

A structure of the electronic device in this application is first described before the chip boot method provided in embodiments of this application is described. FIG. 4 is a diagram of a structure of an electronic device according to an embodiment of this application. With reference to FIG. 4, the electronic device may include a host 41, a chip 42, and a non-volatile memory (NVM) 43.

First, software architectures of the host 41 and the chip 42 are described herein. In an example, the host 41 may include an application layer, a TCP/IP protocol stack, a host-side link control layer, an input/output (I/O) port driver, and a first operating system. For the modules included in the host 41, refer to related descriptions of the host in FIG. 1A. The chip 42 may include an application layer, a TCP/IP protocol stack, an I/O port driver, a chip-side link control layer, a physical layer, a communication module, and a second operating system. For the modules included in the chip 42, refer to related descriptions in FIG. 1B. For the second operating system, refer to related descriptions in FIG. 1A. In an example, processing capabilities of a protocol stack and an application on the chip 42 are weaker than processing capabilities of a protocol stack and an application on the host 41. It should be understood that FIG. 4 does not show the software architectures of the host 41 and the chip 42.

Then, hardware structures of the host 41 and the chip 42 are described. With reference to FIG. 4, the chip 42 may include at least one core. The core may be understood as a processing unit, for example, a core A or a core C, in the chip. The core A is responsible for executing application-related code. The core C is responsible for executing communication-related code. In some embodiments, if there is a complex application, there is an operating system on the core, and is used for scheduling and task management.

The chip 42 includes a memory. The memory may include any one of the following: a random-access memory (RAM), or a static random-access memory (SRAM).

The non-volatile memory 43 is configured to store an image. In an example, the non-volatile memory 43 may be, for example, a flash or a read-only memory (ROM). In an example, the non-volatile memory 43 may be integrated into the chip 42, or the non-volatile memory 43 may be disposed independently of the chip 42. This is not limited in this application. In FIG. 4, for example, the non-volatile memory 43 is a flash, and the flash is disposed independently of the chip 42.

In an embodiment, the host 41 may interact with the chip 42 through the following interfaces: a first interface, a second interface, a third interface, and a fourth interface.

The first interface is configured to implement interaction of a control command between the host 41 and the chip 42. For example, the first interface may be configured to implement that the chip 42 burns an image in the host 41 in the chip 42. In an example, the first interface may be, for example, a universal asynchronous receiver/transmitter (UART) interface, a peripheral component interconnect express (PCI-E) interface, or a serial peripheral interface (SPI). In FIG. 4, for example, the first interface is a UART interface.

The second interface is configured to transmit a high-speed data stream when the electronic device is connected to a network. In an example, the second interface may be a universal serial bus (USB) interface or a secure digital input/output (SDIO) interface. In FIG. 4, for example, the second interface is a USB interface.

The third interface is used by the chip 42 to detect a power on/off status of the host 41. The power on/off status includes a power-on state and a power-off state. The third interface may be a general-purpose input/output (GPIO) interface on the chip 42. In an example, a new GPIO interface may be disposed between the chip 42 and the host 41, or an original GPIO interface between the chip 42 and the host 41 may be used. In FIG. 4, for example, the third interface is a GPIO 1 interface.

The fourth interface is used by the chip 42 to control a power switch of the host 41. The chip 42 may trigger, through the fourth interface, the host 41 to perform a power-on operation. In an example, the fourth interface may be a GPIO interface. In FIG. 4, for example, the fourth interface is a GPIO 2 interface.

It should be understood that FIG. 4 shows the structure of the electronic device, but does not impose a limitation on the structure of the electronic device. In some other embodiments of this application, the electronic device may include more or fewer components than those shown in the figure, or combine some of the components, or split some of the components, or have different arrangements of the components. The components shown in the figure may be implemented by hardware, software, or a combination of the software and the hardware.

With reference to the electronic device shown in FIG. 4 and specific embodiments, the following describes the chip boot method provided in embodiments of this application. The following several embodiments may be combined with each other, and a same or similar concept or process may not be described repeatedly in some embodiments.

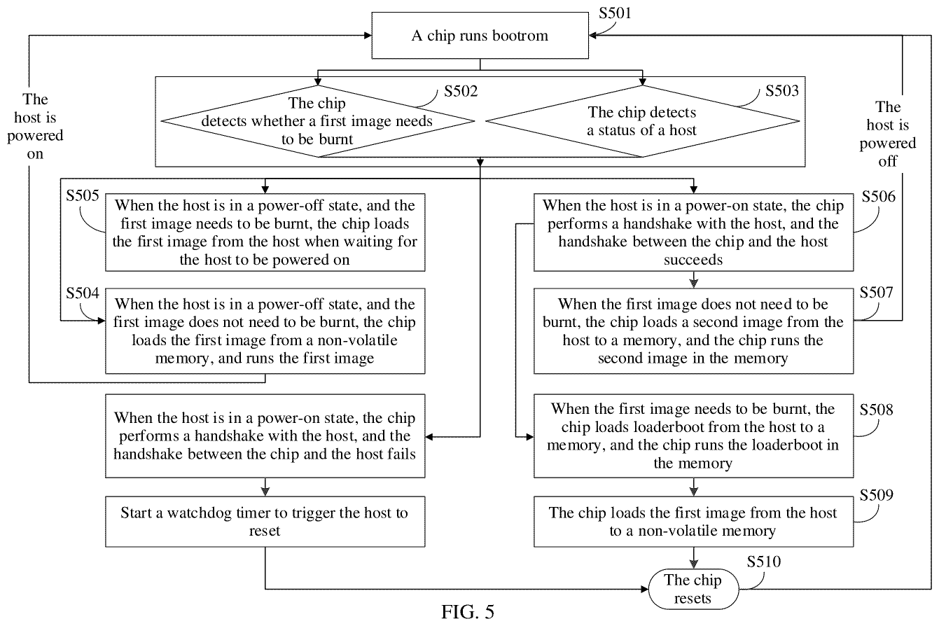

FIG. 5 is a schematic flowchart of an embodiment of a chip boot method according to an embodiment of this application. With reference to FIG. 5, the chip boot method provided in this embodiment of this application may include the following steps.

S501: A chip runs bootrom.

In an embodiment, the chip may run the bootrom when being powered on for the first time or when being powered on after being forcibly powered off, or when the chip resets.

In an embodiment, the chip may run the bootrom in response to detecting that an electronic device is powered on or the electronic device is powered off. With reference to FIG. 4, the chip may detect a status of a host through a third interface. The status of the host is a status of the electronic device.

In an embodiment, in response to detecting that the electronic device is powered on or the electronic device is powered off, the chip may first perform reset, and run the bootrom after the reset.

For example, the third interface is a GPIO interface. When the electronic device is powered on, a level of the GPIO interface may be pulled up to a high level. When detecting that the level of the GPIO interface is pulled up to the high level, the chip may determine that the electronic device is powered on. Correspondingly, when the electronic device is powered off, the level of the GPIO interface may be pulled down to a low level. When detecting that the level of the GPIO interface is pulled down to the low level, the chip may determine that the electronic device is powered off. It may be figured out that, when the electronic device is powered on, the level of the GPIO interface may alternatively be pulled down to the low level, and when the electronic device is powered off, the level of the GPIO interface may be pulled up to the high level. This is not limited in embodiments of this application. It should be understood that the high level may be understood as that a level value is greater than a first threshold, and the low level may be understood as that a level value is less than a second threshold, where the first threshold is greater than the second threshold.

S502: The chip detects whether a first image needs to be burnt.

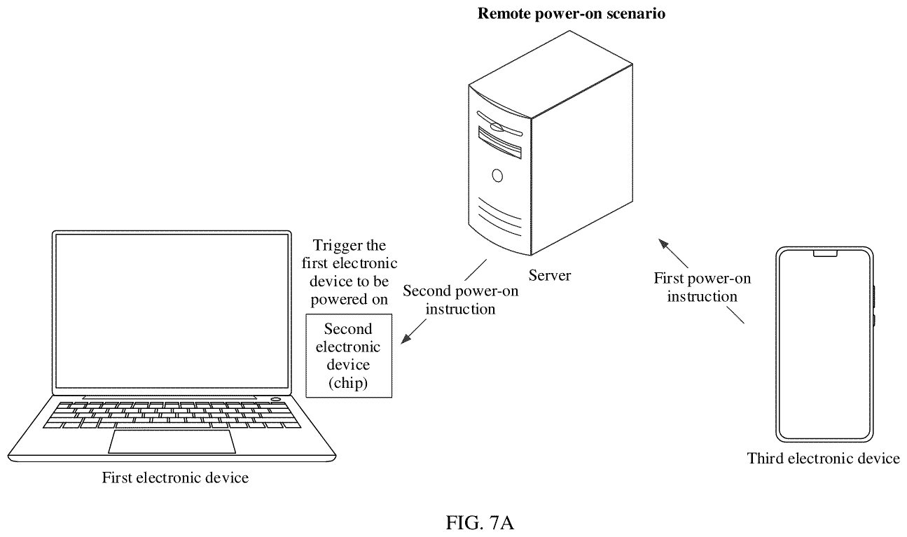

The first image is an image that is run by the chip when the electronic device is powered off. A second image is an image that is by the chip when the electronic device is powered on. The first image is different from the second image. For example, the second image may include a system image and a communication image. For details, refer to related descriptions of an image that is run when a first-type communication chip is booted. For example, the first image may include an application image and a communication image. For details, refer to related descriptions in FIG. 7A and FIG. 7B.

The host may store the first image and the second image. In an example, the host may further update the first image and the second image. In an example, the first image may be referred to as a master off image, and the second image may be referred to as a master on image.

In an embodiment, the chip may detect whether the first image is already burnt in the non-volatile memory, to determine whether the first image needs to be burnt. If the first image exists in the non-volatile memory, the chip may determine that the first image does not need to be burnt. If the first image does not exist in the non-volatile memory, the chip may determine that the first image needs to be burnt.

In an embodiment, because the host may update the first image, when the first image already exists in the non-volatile memory, if the first image in the host is updated, the host may send an update notification to the chip. The update notification indicates that the first image in the host is updated. In response to the update notification, the chip may write a burning flag in the non-volatile memory. The burning flag indicates that the first image needs to be reburnt.

In this embodiment, when the first image exists in the non-volatile memory, the chip can further detect whether the burning flag is written in the non-volatile memory. If the burning flag is written in the non-volatile memory, the chip may determine that the first image needs to be burnt. If the burning flag is not written in the non-volatile memory, the chip may determine that the first image does not need to be burnt.

In an embodiment, the chip may further check the first image when the first image exists in the non-volatile memory. S504, S505, or S506 is performed when the check on the first image succeeds. When the check on the first image fails, S506 and S507, or S506 and S508 to S510 may be performed when the host is powered on. In an example, the chip may perform cyclic redundancy check (CRC) on the first image. A manner of checking the first image is not limited in embodiments of this application.

S503: The chip detects the status of the host.

For S503, refer to related descriptions of S501. There is no sequence between S503 and S502, and S503 and S502 may be performed at the same time.

In an embodiment, an SBL (second bootloader) may be added to the chip. The chip may run the SBL to detect the status of the host, and may determine, based on the status of the host, to perform S504, S505, or S506.

In an embodiment, S503 is an optional step. When the chip runs the bootrom in response to power-on of the electronic device or power-off of the electronic device, the chip can already determine the status of the host, and the chip may not perform S503.

S504: When the host is in a power-off state, and the first image does not need to be burnt, the chip loads the first image from the non-volatile memory, and runs the first image.

When the host is in a power-off state, and the first image does not need to be burnt, that is, the first image exists in the non-volatile memory, the chip may load the first image from the non-volatile memory, and run the first image. Each core in the chip may load a corresponding first image from the non-volatile memory, and run the first image.

For example, the first image includes a Wi-Fi image, a Bluetooth image, and an application image. When the host is in the power-off state, and the first image does not need to be burnt, a core C may load the Wi-Fi image from the non-volatile memory, and run the Wi-Fi image, to implement Wi-Fi communication, and load the Bluetooth image from the non-volatile memory, and run the Bluetooth image, to implement Bluetooth communication; and a core A may load the application image from the non-volatile memory, and run the application image, to implement a function of an application.

In some embodiments, the core C may include a Wi-Fi subsystem and a Bluetooth subsystem. The Wi-Fi subsystem may load the Wi-Fi image from the non-volatile memory, and run the Wi-Fi image, to implement the Wi-Fi communication. The Bluetooth subsystem may load the Bluetooth image from the non-volatile memory, and run the Bluetooth image, to implement the Bluetooth communication.

It should be understood that, after the chip performs S504, the chip may continue to detect the status of the host, and when the host is powered on, may return to perform S501.

S505: When the host is in a power-off state, and the first image needs to be burnt, the chip loads the first image from the host when waiting for the host to be powered on.

When the host is in the power-off state, and the first image needs to be burnt, the chip may not perform a boot procedure, but continues to detect the status of the host, and loads the first image from the host when the host is powered on. For details, refer to related descriptions of S508 to S510.

In an embodiment, when the host is in the power-off state, and the first image does not exist in the non-volatile memory, the chip may load the first image from the host when waiting for the host to be powered on. In an embodiment, when the host is in the power-off state, the first image exists in the non-volatile memory, but the burning flag is written in the non-volatile memory, the chip may first load the first image from the non-volatile memory, run the first image, and continue to detect the status of the host. When the host is powered on, the chip may return to perform S501, to load the first image from the host.

S506: When the host is in a power-on state, the chip performs a handshake with the host, and performs S507 or performs S508 to S510 when the handshake between the chip and the host succeeds.

A first pin and a second pin may be disposed on the chip. The first pin corresponds to a first interface. The second pin corresponds to a second interface. The chip may detect levels of the first pin and the second pin, to detect the handshake with the host through the first interface or the second interface.

In an embodiment, the chip may perform the handshake with the host through the first interface (for example, a UART interface). When the host is in the power-on state, the host may select, for example, the first interface to perform the handshake with the chip. The host may set a level of the first pin to a preset level. In response to the setting of the level of the first pin to the preset level, the chip may determine to perform the handshake with the host through the first interface. For example, the preset level may be a high level or a low level. A process in which the chip performs the handshake with the host through the first interface is not described again in this embodiment of this application. For details, refer to related descriptions in the conventional technology.

If the chip detects that the level of the first pin is not set to the preset level, the chip may continue to detect whether a level of the second pin is set to the preset level. If the level of the second pin is set to the preset level, the chip determines to perform the handshake with the host through the second interface. If the level of the second pin is not set to the preset level, the chip determines that the handshake with the host fails.

In an embodiment, a corresponding pin may not be disposed for the first interface, to reduce pin overheads. In this embodiment, when the host is in the power-on state, the host may send a handshake signal to the chip through the first interface to perform the handshake. Correspondingly, the chip may start a timer to perform timing. Timing duration is, for example, preset duration. If the chip receives the handshake signal from the host through the first interface within the preset duration, the chip determining that the handshake with the host succeeds.

If the chip does not receive the handshake signal from the host through the first interface within the preset duration, the chip may detect whether the level of the second pin is set to the preset level. If the level of the second pin is set to the preset level, the chip determines to perform the handshake with the host through the second interface. If the level of the second pin is not set to the preset level, the chip determines that the handshake with the host fails. In this embodiment, the second pin may be referred to as a preset pin.

In an embodiment, when the handshake between the chip and the host fails, the chip may wait for the host to reset. When the host resets, the chip may perform S510. For example, when the handshake between the chip and the host fails, a watchdog timer may be started, to trigger the host to reset.

S507: When the first image does not need to be burnt, the chip loads the second image from the host to a memory, and runs the second image in the memory.

Similar to that in a boot process of the first-type communication chip, when the host is in the powered-on state, and the handshake between the chip and the host succeeds, if the chip does not need to burn the first image, the chip may load the second image from the host to the memory (for example, an SRAM), and run the second image in the memory.

Each core in the chip may run a corresponding second image. For example, the first image includes a system image, a Wi-Fi image, and a Bluetooth image. A core A may run the system image, to implement running a second operating system. A core C may run the Wi-Fi image, to implement Wi-Fi communication, and run the Bluetooth image, to implement Bluetooth communication.

In some embodiments, the core C may include a Wi-Fi subsystem and a Bluetooth subsystem. The Wi-Fi subsystem may load the Wi-Fi image from the non-volatile memory, and run the Wi-Fi image, to implement the Wi-Fi communication. The Bluetooth subsystem may load the Bluetooth image from the non-volatile memory, and run the Bluetooth image, to implement the Bluetooth communication.

It should be understood that, after the chip performs S507, the chip may continue to detect the status of the host, and when the host is powered off, may return to perform S501.

S508: When the first image needs to be burnt, the chip loads loaderboot from the host to a memory, and runs the loaderboot in the memory.

Similar to that in a boot process of a second-type communication chip, the chip may load the loaderboot from the host to the memory, and run the loaderboot in the memory. For details, refer to related descriptions of the boot process of the second-type communication chip.

S509: The chip loads the first image from the host to the non-volatile memory.

After running the loaderboot, the chip may determine that the first image needs to be burnt. The chip may load the first image from the host to the non-volatile memory, that is, burn the first image in the non-volatile memory. In an example, if the burning flag is written in the non-volatile memory, the chip may delete the burning flag after burning the first image in the non-volatile memory.

S510: The chip resets, and after the reset, returns to perform S501.

The chip may reset after the chip burns the first image in the non-volatile memory.

The chip already loads the first image to the non-volatile memory. Therefore, the chip may perform S502, S503, S506, and S507 after resetting and performing S501.

In an embodiment, a part of the steps shown in FIG. 5 may be optional steps, and the steps may be combined with each other.

In this embodiment of this application, the chip can detect the status of the host and whether the first image needs to be burnt in the non-volatile memory. The chip may execute different strategies based on the status of the host and a result of whether the first image needs to be burnt in the non-volatile memory. This can ensure that the host (or the electronic device) can implement communication in the power-on state or the power-off state. In addition, when the host is in the power-on state, the chip can load the second image from the host to the memory, and the host provides a protocol stack and an application that have strong processing capabilities. This can meet a requirement of a user for high network performance.

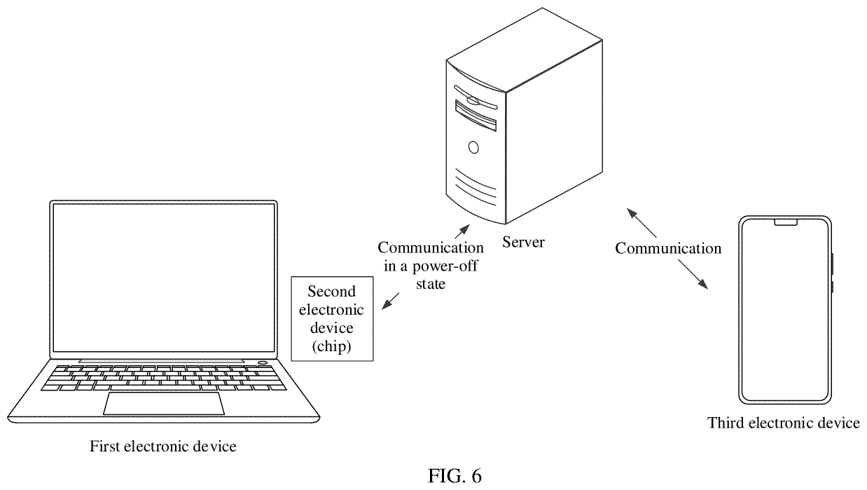

With reference to several example application scenarios, the following describes a scenario in which an electronic device can still perform communication after being powered off. FIG. 6 is a diagram of a system architecture to which a chip boot method is applicable according to an embodiment of this application. With reference to FIG. 6, the system architecture may include a first electronic device, a second electronic device, a server, and a third electronic device.

The first electronic device may be used as the electronic device in FIG. 4. The first electronic device includes the host 41. The second electronic device includes a chip. The chip may be used as the chip 42 in FIG. 4. In FIG. 6, for example, the chip 42 is disposed independently of the first electronic device. In FIG. 6, for example, the first electronic device is a PC. In an example, the second electronic device may alternatively be a chip disposed in the PC.

For a form of the third electronic device, refer to related descriptions of the form of the electronic device in the foregoing embodiment. The form of the third electronic device is not specifically limited in embodiments of this application. In FIG. 6, for example, the third electronic device is a mobile phone.

The server is configured to: record a status of the first electronic device, and bind the first electronic device to the second electronic device. That the server binds the first electronic device to the second electronic device may be understood as that the server records a correspondence between the first electronic device and the second electronic device. For example, the server may communicate with the second electronic device when the first electronic device is powered off.

An improvement of this embodiment of this application lies in the chip in the second electronic device. The chip can achieve effect that one core has two functions. When the first electronic device is powered on, the chip in the second electronic device may load a second image from the host in the first electronic device, and run the second image. In this way, the first electronic device is networked, and communicates with other devices (for example, the server and the third electronic device). When the first electronic device is powered off, the chip in the second electronic device may run a first image in a flash. In this way, the first electronic device communicates with the other electronic devices. For details, refer to related descriptions in the embodiment shown in FIG. 5.

The following mainly describes a scenario in which the second electronic device assists the first electronic device in implementing communication when the first electronic device is in a power-off state.

In an embodiment, when the first electronic device is powered off, the chip in the second electronic device may run the first image in the flash based on related descriptions in FIG. 5, to implement communication. When the first electronic device is powered off, the chip in the second electronic device may periodically send heartbeat information to the server. In this way, the server may determine, based on the heartbeat information, that the chip in the second electronic device can perform communication, and determine that the first electronic device is powered off.

In an example, the server may record the status of the first electronic device as the power-off state.

### Scenario 1: Remote Power-on

In this scenario, the first image may include a communication image. The communication image is, for example, a Wi-Fi image. When the first electronic device is powered off, the chip in the second electronic device may run the Wi-Fi image, to implement communication with the server. In this scenario, if a Bluetooth gateway exists, the first image may include a communication image. The communication image is, for example, a Bluetooth image. When the first electronic device is powered off, the chip in the second electronic device may run the Bluetooth image, to implement communication with the server through the Bluetooth gateway.

In an embodiment, the third electronic device may request the server to query the status of the first electronic device. For example, the third electronic device may query the status of the first electronic device using an application installed on the third electronic device. When the third electronic device finds that the first electronic device is in the power-off state, a user may operate the third electronic device to implement the remote power-on of the first electronic device.

With reference to FIG. 7A, for example, the third electronic device may send a first power-on instruction to the server. The first power-on instruction may include an identifier of the first electronic device. The first power-on instruction indicates the server to control, via the chip in the second electronic device, the first electronic device to be powered on. The identifier of the first electronic device is information that uniquely identifies the first electronic device, for example, an international mobile equipment identity (IMEI) or a serial number of the first electronic device. For example, the first electronic device may receive, for example, through an application programming interface (API) or a graphical user interface (GUI), a power-on indication triggered by the user, to send the first power-on instruction to the server. A manner in which the user triggers the third electronic device is not limited in embodiments.

The server may send a second power-on instruction to the chip in the second electronic device in response to the first power-on instruction. The second power-on instruction indicates the chip in the second electronic device to control the first electronic device to be powered on. In this scenario, in response to receiving the second power-on instruction from the server, the chip in the second electronic device may send a third power-on instruction to the first electronic device through a fourth interface, to trigger the first electronic device to be powered on. Alternatively, when the fourth interface is a GPIO interface, the chip in the second electronic device may set a level of the GPIO interface to a preset level in response to receiving the second power-on instruction from the server. The first electronic device may perform a power-on operation in response to setting the level of the fourth interface to the preset level.

After the first electronic device is powered on, the chip in the second electronic device detects that the first electronic device is powered on, and may perform reset. After resetting, the chip may perform S501 to S503, and correspondingly perform S504, S505, and S506 and S507, or S506 to S510 based on whether an image needs to be burnt and a status of the host, to implement the chip boot method provided in embodiments of this application.

### Scenario 2: Device Retrieval

In this scenario, the first image may include a communication image (for example, a Bluetooth image) and a device retrieval application image.

When the first electronic device is powered off, the chip in the second electronic device may run the device retrieval application image and the Bluetooth image. With reference to FIG. 7B, the chip in the second electronic device runs the device retrieval application image, and may trigger the second electronic device to send a Bluetooth broadcast via a Bluetooth module. The Bluetooth broadcast may include information such as a device retrieval identifier and an identifier of the first electronic device.

For example, the third electronic device enables a device retrieval function. If the third electronic device receives the Bluetooth broadcast from the second electronic device, the third electronic device may obtain a location of the second electronic device based on the device retrieval identifier in the Bluetooth broadcast. A manner in which the third electronic device obtains the location of the second electronic device is not limited in embodiments of this application. For example, the third electronic device may obtain the location of the second electronic device based on a signal strength of the Bluetooth broadcast.

The third electronic device may include the location of the second electronic device in a Bluetooth broadcast, and relay to send the information to the server. The server may store the identifier of the first electronic device and the location of the second electronic device. In an example, the first electronic device and the second electronic device are usually disposed together. Therefore, the server may use the location of the second electronic device as a location of the first electronic device. For example, the server may store the identifier of the first electronic device and the location of the first electronic device.

In this way, a user may log in to a target account from another device, and obtain the location of the first electronic device from the server through querying. The target account may be an account logged in on the first electronic device.

In this embodiment of this application, when the first electronic device is in the power-off state, the broadcast used for device retrieval can be still sent via the chip of the second electronic device bound to the first electronic device. In this way, the third electronic device can report the location of the second electronic device to the server based on the broadcast. The user can obtain the location of the powered-off first electronic device by logging in to a same account. This helps the user retrieve the first electronic device.

In this embodiment, compared with that in the conventional technology, there is no need to additionally add a Bluetooth chip to the first electronic device. The Bluetooth chip is configured to implement retrieval of the first electronic device in the power-off state. This can reduce costs and simplify setting of the electronic device.

### Scenario 3: Wireless Sensing

In this scenario, the first image may include a wireless sensing image. The wireless sensing image is, for example, a radar image. When the first electronic device is powered off, the chip in the second electronic device may run the radar image, to implement a radar sensing function of the second electronic device.

The chip in the second electronic device may sense a posture of a surrounding user using the radar sensing function, and further perform a corresponding operation. For example, when detecting that the user falls down, the second electronic device may send an alarm for promotion. For example, the second electronic device is a speaker. When detecting that the user approaches, the second electronic device may play an audio. A manner of using the radar sensing function by the second electronic device is not limited in embodiments of this application.

In this embodiment of this application, a scenario in which the first electronic device can still perform communication after being powered off is not exhaustive. It may be figured out that, on a basis of the chip boot method provided in this application, a research and development personnel may design different first images, so that after the first electronic device is powered off, the chip of the second electronic device runs different first images, to perform different operations, so as to implement different functions.

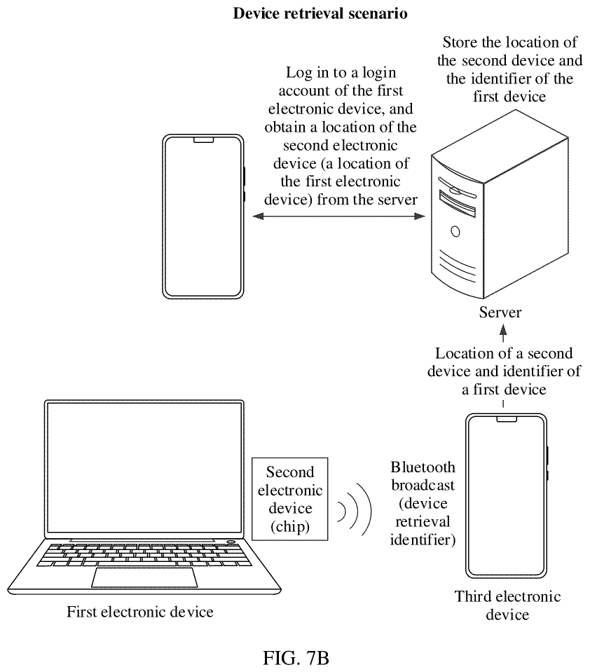

In conclusion, with reference to FIG. 8, a chip boot method provided in an embodiment of this application may include the following steps.

S801: When a chip is booted, detect whether a first image needs to be burnt in a non-volatile memory, where the first image is an image that is run by the chip when an electronic device is in a power-off state.

In this embodiment of this application, when the chip is booted, it may be detected whether the first image needs to be burnt in the non-volatile memory. The first image is an image that is run by the chip when the electronic device is in a power-off stat. A second image is an image that is run by the chip when the electronic device is in a power-on state. The first image is different from the second image.

For S801, refer to related descriptions of S502.

S802: Perform different boot operations based on a status of the electronic device and a result of whether the first image needs to be burnt in the non-volatile memory, where the status of the electronic device includes the power-on state and the power-off state.

The status of the electronic device includes the power-on state and the power-off state. The result of whether the first image needs to be burnt in the non-volatile memory includes: The first image needs to be burnt in the non-volatile memory and the first image does not need to be burnt in the non-volatile memory. In some embodiments, the status of the electronic device may be further detected. For details, refer to related descriptions of S503.

In this embodiment of this application, different boot operations may be performed based on the status of the electronic device and the result of whether the first image needs to be burnt in the non-volatile memory. For details, refer to related descriptions of S504 to S510.

The chip boot method provided in this embodiment of this application has a same principle and technical effect as those in the foregoing embodiment. For details, refer to related descriptions in the foregoing embodiment. Details are not described herein again.

In an embodiment, an embodiment of this application further provides a chip. For a structure of the chip, refer to related descriptions of the chip 42 in FIG. 4. The chip may perform the steps performed by the chip shown in FIG. 5 in the foregoing embodiment, to implement the chip boot method provided in embodiments of this application.

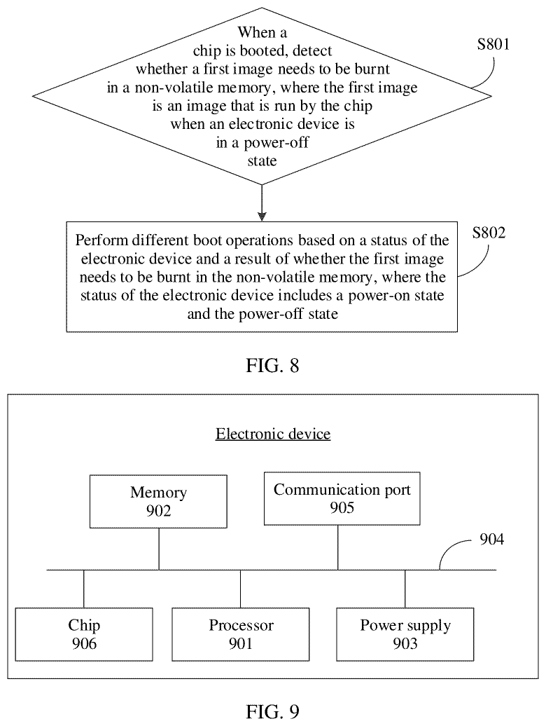

In an embodiment, an embodiment of this application further provides an electronic device. With reference to FIG. 9, the electronic device may include a processor 901 (for example, a CPU) and a memory 902. The memory 902 may include a high-speed random-access memory (random-access memory, RAM), and may further include a non-volatile memory (non-volatile memory, NVM), for example, at least one magnetic disk memory. The memory 902 may store various instructions, to complete various processing functions and implement the steps of the methods in this application.

The electronic device in this application may further include a power supply 903, a communication bus 904, and a communication port 905. The communication port 905 is configured to implement a connection and communication between the electronic device and another peripheral device. In this embodiment of this application, the memory 902 is configured to store computer-executable program code. The program code includes instructions. When the processor 901 executes the instructions, the instructions enable the processor 901 of the electronic device to perform the actions in the foregoing method embodiments. Implementation principles and technical effect thereof are similar to those in the foregoing method embodiments. Details are not described herein again.

The electronic device may further include a chip 906. The chip 906 may be used as the chip 42 shown in FIG. 4. In an example, a non-volatile memory 43 may be disposed in the chip 906, or the non-volatile memory 43 may be disposed independently of the chip 906. In other words, the electronic device may further include the non-volatile memory 43. In FIG. 9, for example, the non-volatile memory 43 is disposed in the chip 906.

It should be noted that the modules or components in the foregoing embodiments may be configured as one or more integrated circuits for implementing the foregoing methods, for example, one or more application-specific integrated circuits (ASIC), one or more microprocessors (DSPs), or one or more field programmable gate arrays (FPGAs). For another example, when one of the foregoing modules is implemented in a form of invoking program code by a processing element, the processing element may be a general-purpose processor, for example, a central processing unit (CPU) or another processor that can invoke the program code, for example, a controller. For another example, these modules may be integrated, and implemented in a form of a system-on-a-chip (SoC).

The foregoing embodiments may be all or partially implemented by software, hardware, firmware, or any combination thereof. When being implemented by software, the foregoing embodiments may be all or partially implemented in a form of a computer program product. The computer program product includes one or more computer instructions. When the computer program instructions are loaded and executed on a computer, the procedure or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid state drive (SSD)), or the like.

The term “a plurality of” in this specification means two or more. The term “and/or” in this specification describes only an association relationship for associated objects, and indicates that three relationships may exist. For example, A and/or B may indicate the following three cases: Only A exists, both A and B exist, and only B exists. In addition, the character “/” in this specification generally indicates an “or” relationship between associated objects, and the character “/” in a formula indicates a “division” relationship between associated objects. In addition, it should be understood that, in descriptions of this application, terms such as “first” and “second” are merely used for a purpose of distinguishing descriptions, but should not be understood as indicating or implying relative importance, or should not be understood as indicating or implying a sequence.

It may be understood that various numbers in embodiments of this application are merely used for differentiation for ease of description, and are not used to limit the scope of embodiments of this application.

It may be understood that sequence numbers of the foregoing processes do not mean execution sequences in embodiments of this application. The execution sequences of the processes should be determined based on functions and internal logic of the processes, and should not be construed as any limitation on the implementation processes of embodiments of this application.

What is claimed is:

1. A method, applied to a chip, the method comprising:
when the chip is booted, detecting whether a first image needs to be burnt in a non-volatile memory, wherein the first image is run by the chip when an electronic device is in a power-off state; and
performing a boot operation based on a status of the electronic device and a result of whether the first image needs to be burnt in the non-volatile memory, wherein the status of the electronic device comprises a power-on state and the power-off state, and different boot operations are performed based on different statuses of the electronic device and different results of whether the first image needs to be burnt in the non-volatile memory.

2. The method according to claim 1, wherein detecting whether the first image needs to be burnt in the non-volatile memory comprises:
detecting whether the first image exists in the non-volatile memory, and detecting whether a burning flag is written in the non-volatile memory, wherein the burning flag indicates that the first image needs to be burnt in the non-volatile memory; and
when the first image exists in the non-volatile memory, and the burning flag is not written in the non-volatile memory, the result is that the first image does not need to be burnt in the non-volatile memory; and
when the first image does not exist in the non-volatile memory, or the burning flag is written in the non-volatile memory, the result is that the first image needs to be burnt in the non-volatile memory.

3. The method according to claim 1, wherein detecting whether the first image needs to be burnt in the non-volatile memory comprises:
in response to power on of the chip, detecting whether the first image needs to be burnt in the non-volatile memory; or
in response to reset of the chip, detecting whether the first image needs to be burnt in the non-volatile memory; or
in response to power on or power off of the electronic device, detecting whether the first image needs to be burnt in the non-volatile memory.

4. The method according to claim 3, further comprising:
detecting the status of the electronic device.

5. The method according to claim 1, wherein performing the boot operation based on the status of the electronic device and the result of whether the first image needs to be burnt in the non-volatile memory comprises:
when the electronic device is in the power-off state, and the first image does not need to be burnt in the non-volatile memory, loading the first image from the non-volatile memory, and running the first image; and
when the electronic device is in the power-off state, and the first image needs to be burnt in the non-volatile memory, waiting for the electronic device to be powered on.

6. The method according to claim 1, wherein performing the boot operation based on the status of the electronic device and the result of whether the first image needs to be burnt in the non-volatile memory comprises:
when the electronic device is in the power-on state, performing a handshake with a host in the electronic device, wherein the host comprises the first image and a second image, the second image is run by the chip when the electronic device is in the power-on state, and the first image is different from the second image;
when the handshake with the host succeeds, and the first image does not need to be burnt in the non-volatile memory, loading the second image from the host to a memory of the chip, and running the second image in the memory; and
when the handshake with the host succeeds, and the first image needs to be burnt in the non-volatile memory, loading the first image from the host to the non-volatile memory, and performing reset after the loading is completed.

7. The method according to claim 6, wherein before loading the first image from the host to the non-volatile memory, the method further comprises:
loading a bootloader image from the host to the memory of the chip, and running the bootloader image in the memory.

8. The method according to claim 6, further comprising:
when the handshake with the host fails, waiting for the host to reset; and
performing reset when the host resets.

9. The method according to claim 6, wherein the chip is connected to the host through a first interface and a second interface; and
the method further comprises:
when the electronic device is in the power-on state, starting a timer to perform timing, wherein timing duration is preset duration;
when a handshake signal from the host is received through the first interface within the preset duration, determining that the handshake with the host succeeds;
when the handshake signal from the host is not received through the first interface within the preset duration, detecting whether a level of a preset pin of the chip is set to a preset level, wherein the preset pin corresponds to the second interface; and
when the level of the preset pin is set to the preset level, determining to perform the handshake with the host through the second interface.

10. The method according to claim 2, further comprising:
receiving an update notification from a host in the electronic device, wherein the update notification indicates that the first image in the host is updated; and
writing the burning flag in the non-volatile memory.

11. The method according to claim 1, wherein the first image comprises a communication image, and the communication image is used to implement communication when the electronic device is powered off.

12. The method according to claim 11, wherein the first image further comprises an application image, and the application image is used to implement a function of an application when the electronic device is powered off.

13. The method according to claim 12, wherein the application image is used to: when the electronic device is powered off, trigger the chip to send a broadcast, wherein the broadcast is used to retrieve the electronic device.

14. A chip, comprising a computer program or instructions, and when the computer program or the instructions are run, the chip is enabled to perform the following:
when the chip is booted, detecting whether a first image needs to be burnt in a non-volatile memory, wherein the first image is an image that is run by the chip when an electronic device is in a power-off state; and
performing a boot operation based on a status of the electronic device and a result of whether the first image needs to be burnt in the non-volatile memory, wherein the status of the electronic device comprises a power-on state and the power-off state, and different boot operations are performed based on different statuses of the electronic device and different results of whether the first image needs to be burnt in the non-volatile memory.

15. The chip according to claim 14, wherein detecting whether the first image needs to be burnt in the non-volatile memory comprises:
detecting whether the first image exists in the non-volatile memory, and detecting whether a burning flag is written in the non-volatile memory, wherein the burning flag indicates that the first image needs to be burnt in the non-volatile memory;
when the first image exists in the non-volatile memory, and the burning flag is not written in the non-volatile memory, the result is that the first image does not need to be burnt in the non-volatile memory; and
when the first image does not exist in the non-volatile memory, or the burning flag is written in the non-volatile memory, the result is that the first image needs to be burnt in the non-volatile memory.

16. The chip according to claim 14, wherein detecting whether the first image needs to be burnt in the non-volatile memory comprises:
in response to power on of the chip, detecting whether the first image needs to be burnt in the non-volatile memory; or
in response to reset of the chip, detecting whether the first image needs to be burnt in the non-volatile memory; or
in response to power on or power off of the electronic device, detecting whether the first image needs to be burnt in the non-volatile memory.

17. The chip according to claim 16, wherein when the computer program or the instructions are run, the chip is further enabled to perform the following steps:
detecting the status of the electronic device.

18. The chip according to claim 14, wherein performing the boot operation based on the status of the electronic device and the result of whether the first image needs to be burnt in the non-volatile memory comprises:
when the electronic device is in the power-off state, and the first image does not need to be burnt in the non-volatile memory, loading the first image from the non-volatile memory, and running the first image; and
when the electronic device is in the power-off state, and the first image needs to be burnt in the non-volatile memory, waiting for the electronic device to be powered on.

19. The chip according to claim 14, wherein performing the boot operation based on the status of the electronic device and the result of whether the first image needs to be burnt in the non-volatile memory comprises:
when the electronic device is in the power-on state, performing a handshake with a host in the electronic device, wherein the host comprises the first image and a second image, the second image is an image that is run by the chip when the electronic device is in the power-on state, and the first image is different from the second image;
when the handshake with the host succeeds, and the first image does not need to be burnt in the non-volatile memory, loading the second image from the host to a memory of the chip, and running the second image in the memory; and
when the handshake with the host succeeds, and the first image needs to be burnt in the non-volatile memory, loading the first image from the host to the non-volatile memory, and performing reset after the loading is completed.

20. The chip according to claim 19, wherein before loading the first image from the host to the non-volatile memory, when the computer program or the instructions are run, the chip is further enabled to perform the following steps:
loading a bootloader image from the host to the memory of the chip, and running the bootloader image in the memory.
